(19) United States
(12) Patent Application Publication
(10) Pub. No.: US 2021/0283986 A1
(43) Pub. Date: Sep. 16, 2021

(54) ELECTRICAL HEATER WITH HEATING REGISTERS MADE OF PTC-ELEMENTS WHICH ARE COUPLED THERMALLY IN SERIES

(71) Applicant: Mahle International GmbH, Stuttgart (DE)

(72) Inventors: Simon Dangelmaier, Stuttgart (DE); Marcel Huelss, Stuttgart (DE); Falk Viehrig, Stuttgart (DE); Robin Wanke, Stuttgart (DE); Denis Wiedmann, Fellbach (DE)

(21) Appl. No.: 17/198,234

(22) Filed: Mar. 10, 2021

(30) Foreign Application Priority Data
Mar. 11, 2020 (DE) 102020203130.4

(51) Int. Cl. B60H 1/22; H05B 1/02

(52) U.S. Cl. CPC B60H 1/2218; B60H 1/2225; H05B 2203/023; B60H 2001/224; H05B 2203/02; H05B 1/0236

(57) ABSTRACT

A heating arrangement may include a first PTC heating device with at least one first PTC heating element, and a second PTC heating device with at least one second PTC heating element. The first and second PTC heating devices may be arranged in a through-flow direction one behind the other. The first and second PTC heating devices may be controllable independently of one another via a controller.

### CROSS-REFERENCE TO RELATED APPLICATIONS

This application claims priority to German Patent Application No. DE 10 2020 203 130.4, filed on Mar. 11, 2020, the contents of which is hereby incorporated by reference in its entirety.

### TECHNICAL FIELD

The present invention relates to a heating arrangement, in particular for a motor vehicle. Apart from this, the invention relates to a method for operating such a heating arrangement and to an air-conditioning system of a motor vehicle having such a heating arrangement.

### BACKGROUND

From EP 1 780 061 B1 a generic heating arrangement with a first heating device having at least one first PTC heating element and a second heating device having at least one second PTC heating element is known. The two heating devices are arranged one after the other in through-flow direction. In order to be able to achieve different air temperatures, the heating arrangement can be flowed through by parallel air flows, wherein a first air flow flows only through the first heating device and a second air flow flowing parallel thereto, through the first and second heating device. The two heating devices can be either switched on or switched off.

From EP 1 452 357 B1 a heating arrangement is likewise known with a first heating device and a second heating device which are controllable separately from one another. By way of this, the generated quantity of heat for adjacent regions is to be separately meterable, in particular without flap control. There, too, the individual heating devices can be switched on or switched off for influencing an air flow through these.

Especially new generations of electric heating arrangements in electric vehicles are to be no longer operated in the 12V vehicle electrical system, but directly at the battery voltage level of 400V or in the future even 800V. When heating up a purely electric PTC heater, self-heating upon voltage application and reduction of its electrical resistance occurs up to a minimum (NTC range) occurs as a consequence of the characteristic of a PTC heating element, whereas the desired rapid down-regulation by way of the characteristic resistance increase occurs (PTC range). The transition between the NTC and the PTC range is referred to as turning point. This turning point is passed through upon every activation of the PTC heater so that the maximum current developing in the process has to be taken into account for the design of all components, in particular also conductor tracks, PCB, IGBT, connectors etc. Particularly during the heating-up process, a pulse width modulation (PWM) also leads to large voltage and current peaks which are caused by capacitances and inductances. In the process, the vehicle electrical system load can exceed impermissible values and lead to component failure.

Electric heating arrangements generally consist of simple heating registers or heating devices which consist of a single heating stage having one or multiple PTC heating elements and have a defined working point. In order to be able to completely cover a requested output curve, conventional components are thus designed for the maximum operating conditions with the consequence that during the normal operation unnecessary regulating strategies for reducing output are required which in turn can lead to an increased vehicle electrical system loading.

Furthermore, a cost-effective and reliable temperature measurement combined with a flow measurement can currently be realised merely by means of additional sensor technology and regulating equipment effort.

### SUMMARY

The present invention therefore deals with the problem of stating an improved or at least an alternative embodiment for a heating arrangement of the generic type, which in particular makes possible a comparatively simple individual regulation of a heating output with a reduction of the load in a vehicle electrical system at the same time.

According to the invention, this problem is solved through the subject matter of the independent claim(s). Advantageous embodiments form the subject matter of the dependent claim(s).

The present invention is based on the general idea of equipping a heating arrangement, for example in a motor vehicle, with a first PTC heating device having at least one first PTC heating element and with a second PTC heating device having at least one second PTC heating element and arranging these one behind the other in the through-flow direction, wherein a device is provided by means of which the two PTC heating devices can be controlled independently of one another. This means that for example for a lower requested heating output merely one of the two PTC heating devices is activated, while for a higher requested heating output both PTC heating devices can be activated. Here, the individual PTC heating devices can also be controlled differently, for example by means of constant voltage or by means of pulse width modulation.

In an advantageous further development of the solution according to the invention, the first PTC heating device has a first reference temperature T_{1Ref} and the second PTC heating device a second reference temperature T_{2Ref}, wherein (T_{2Ref}−T_{1Ref})>5° Celsius applies. A typical diagram of a resistance profile as a function of the temperature of a PTC heating device initially shows a so-called NTC range (negative temperature coefficient) and subsequently a PTC range (positive temperature coefficient). The transition between the NTC range and the PTC range is the turning point, briefly also referred to as the starting temperature T_{A}. In the NTC range, the electrical resistance is reduced with rising temperature up to a low point, namely the starting temperature T_{A}. With increasing temperature the resistance rises again. Here, the reference temperature T_{Ref} is determined in that at the starting temperature T_{A} twice the resistance is taken and from the same a parallel routed to the abscissa until this parallel intersects the resistance curve. Read off the abscissa, the reference temperature T_{Ref} of the respective PTC heating device is now situated in this point. The resistance profile can be determined by a corresponding mixture of the materials used for the PTC heating device. By way of a delta of the two reference temperatures of the first and second PTC heating device of greater than 5° Celsius or greater than 5 Kelvin, the great advantage can be achieved that the entire heating arrangement can generate all heating outputs better and in particular with a lower load for a vehicle electrical system. By way of such a □T_{Ref} of greater than 5° C. it can also be achieved that the individual PTC heating devices have different working ranges, wherein a working range of such a PTC heating device extends between a nominal temperature TN and an end temperature T_{E}. By way of the different reference temperatures, a major increase of the resistance in the working range can be shifted in that the entire resistance curve is shifted. This is of great advantage in particular provided that the second PTC heating device has a higher reference temperature T_{2Ref} than the first PTC heating device, since the air flowing through the heating arrangement and to be heated initially flows through the first PTC heating device and subsequently through the second PTC heating device. In the process, the through-flowing air or generally the through-flowing fluid is already heated via the first PTC heating device and meets the second heating device with a significantly higher temperature. By way of this it is possible to operate the entire heating arrangement with the at least two PTC heating devices so that each of the two PTC heating devices can be operated in an operating point or heating output range that is optimal in each case.

In a further advantageous embodiment of the solution according to the invention (T_{2Ref}−T_{1Ref})>10° Celsius or even>15° Celsius applies. Depending on the intended field of application it can be advantageous to increase a delta of the reference temperatures in order to be able to operate the respective PTC heating devices in their respective optimal working point or heating output range.

In a further advantageous embodiment of the heating arrangement according to the invention the device is designed in such a manner that at least the second PTC heating device is controllable by means of pulse width modulation. By way of this it is possible to continuously adjust via the pulse width modulation a heating output of 0 to 100%, as a result of which in particular highly diverse operating temperatures can be adjusted and not only a single one, as for example with a PTC heating device that can be merely switched on and off.

In a further advantageous embodiment of the heating arrangement according to the invention, at least the second PTC heating device has a size and/or form other than the first PTC heating device. Through different forms and sizes, the heating output that can be generated with the respective PTC heating device can likewise be influenced.

Practically, at least the first and the second PTC heating device form a common assembly, i.e. these are permanently joined to one another. This offers the major advantage that such an assembly can be easily produced and installed and because of the at least two heating registers or at least two PTC heating devices covers a large area of a specified output curve.

The present invention is based on the general idea of stating a method for operating a previously described heating arrangement having at least two PTC heating devices, in which a heating output of at least one PTC heating device is adjusted by means of pulse width modulation. Here, the other PTC heating device can be operated with constant voltage, i.e. merely switched on and switched off. By way of this it is comparatively easily possible to implement with the first PTC heating device a constant heating stage and with the second PTC heating device a finely tuneable PWM-controlled heating stage. In the case of a minimum requested heating output, for example merely one, preferentially the second PTC heating device can thus be controlled via a pulse width modulation. To increase the desired heating output, the pulse width can be enlarged until it amounts to 100%. When the heating arrangement comprises for example two PTC heating devices generating the same heating output, a heating output between 0 and 100% of the second PTC heating device and thus 50% of the heating output of the entire heating arrangement can thus be adjusted via the pulse width-modulated PTC heating device, here the second PTC heating device, depending on selected pulse width. If this heating output is now to be maintained, the first PTC heating device can be switched on and operated with constant voltage while the second PTC heating device is switched off. By switching off the pulse width-modulated second PTC heating device, voltage and current peaks and thereby a vehicle electrical system load are reduced in particular. Purely theoretically it is obviously also conceivable to control both the first and also the second PTC heating device by means of pulse width modulation and thereby adjust the pulse widths of both PTC heating devices to 50% each. However this requires a greater control/regulating effort and increases the load for the vehicle electrical system. If the heating output is to be further increased, the first PTC heating device for example can be continued to be operated with constant voltage while the second PTC heating device can be operated by means of pulse width modulation and in the process the pulse width increased from 0 to 100%. With a flattening output request, the second switched-on PTC heating device can be again reduced in its output, i.e. in its pulse width. By superimposing the heating output of the first and second PTC heating device, the entire working range can be optimally covered without the heating arrangement having to be designed for comparatively high vehicle electrical system loads of two simultaneously pulse width-modulated PTC heating devices, since independently of the selected heating output range, only the second PTC heating device is always pulse width-modulated while the first PTC heating device constitutes a constant heating stage.

In an advantageous further development of the solution according to the invention of the method according to the invention exclusively the second PTC heating device is subjected in a first range to a pulse width of 0%≤w≤100% and thus a heating output between H₀≤H≤H₁ adjusted. When the heating output H reaches the heating output H₁, i.e. H=H₁, the pulse width w of the second PTC heating device is down-regulated to 0% and thereby the second PTC heating device switched off, while the first PTC heating device is operated with constant voltage without pulse width modulation and H=H₁ thereby maintained. In a second range, the first PTC heating device is now continued to be operated with constant voltage and the second PTC heating device again subjected to a pulse width of 0≤w≤100% by means of pulse width modulation. By way of this, a heating output between H₁≤H≤H₂ can be adjusted. By means of such a method according to the invention, the entire heating output range can thus be extremely finely adjusted and covered, wherein merely one PTC heating device requires an increased regulating effort, i.e. via the pulse width modulation. Here it is obviously clear that by means of such a method further PTC heating devices can also be embodied, for example a three-stage heating arrangement.

The present invention, furthermore, is based on the general idea of equipping an air-conditioning system of a motor vehicle with such a heating arrangement and by way of this transfer the previously mentioned advantages in terms of reducing the voltage and current peaks. By way of this, a vehicle electrical system load which would occur with two pulse width-modulated PTC heating devices in particular can also be significantly reduced. By means of such a heating arrangement, the PTC heating devices employed therein or the PTC heating elements inserted therein can also be designed smaller since it is a multi-stage heating arrangement and it is thus no longer required that the individual PTC heating elements are designed for the maximum conditions.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically:

FIG. 1 shows a heating arrangement according to the invention,

FIG. 2 shows a resistance-temperature profile of a possible PTC heating element,

FIG. 3 shows a heating output of a pulse width-modulated second PTC heating device,

FIG. 4 shows a heating output of a first PTC heating device that is not pulse width-modulated,

FIG. 5 shows a cumulated heating output of the first PTC heating device and the second PTC heating device.

### DETAILED DESCRIPTION

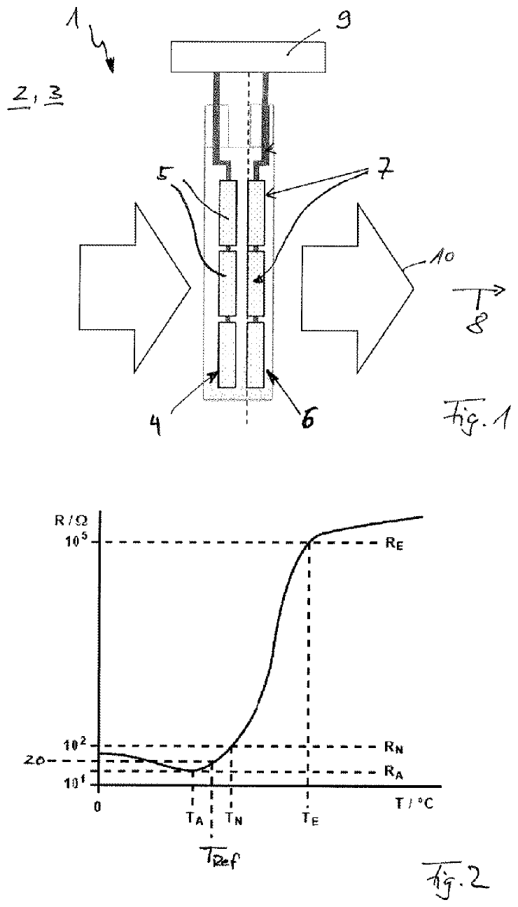

According to FIG. 1, a heating arrangement 1 according to the invention, which can be arranged for example in an air-conditioning system 2 of a motor vehicle 3, comprises a first PTC heating device 4 having at least one, here altogether three first PTC heating elements 5, and a second PTC heating device 6 having at least one, here likewise altogether three second PTC heating elements 7. Here, the two PTC heating devices 4, 6 are arranged one after the other in the through-flow direction 8 and are therefore flowed through one after the other by a fluid flow to be heated, for example air 10. Likewise provided is a device 9, for example a control/regulating device, via which the two PTC heating devices 4, 6 can be controlled independently of one another. This offers the major advantage that depending on the requested heating output H either the first or the second PTC heating device 4, 6 or both PTC heating devices 4, 6 can be activated.

Through the alternative controlling of both PTC heating devices 4, 6 or their cumulative controlling with different outputs each it is possible for the first time to completely cover an entire requested output curve with respect to a heating output H and not only, as in the past, individual working points or extracts of the heating output range, as has been possible with conventional electric heaters that could only be switched on and switched off.

In an advantageous further development of the heating arrangement 1 according to the invention, the first PTC heating device 4 has a first reference temperature T_{1Ref} and the second PTC heating device 6 a second reference temperature T_{2Ref}, wherein (T_{2Ref}−T_{1Ref})>5° Celsius or >5 Kelvin applies.

Here, the reference temperature T_{Ref} is determined as follows: according to FIG. 2, an exemplary resistance-temperature curve of a possible PTC heating device 4, 6 is shown. Up to a starting temperature T_{A}, such a PTC heating device 4, 6 has an NTC range (negative temperature coefficient), in which the resistance R falls with increasing temperature T until the resistance R, at the starting temperature T_{A}, has reached its low point. The temperature at the turning point is also referred to as T_{A}. Following this, the PTC heating device 4, 6 upon a further heating changes into the PTC range (positive temperature coefficient), in which the resistance R increases greatly with the temperature T. The reference temperature T_{Ref} is not determined in each PTC heating device 4, 6 in that at the starting temperature T_{A} twice the resistance according to FIG. 2, i.e. in the example R=20 Ohm, is assumed and at this ohmic value a point of intersection with the resistance-temperature curve searched in the PTC range. At this point, the associated reference temperature T_{Ref} is read off the abscissa. Through the arrangement of two PTC heating devices 4, 6 that are different with respect to their reference temperature T_{Ref} it is possible to operate the two PTC heating devices 4, 6 nearer to their optimal working point and because of this improve both the output of the heating arrangement 1 and also minimise any voltage or current peaks that may occur.

Since upon an activation of the heating arrangement 1 the air 10 flowing through is already heated in the first PTC heating device 4 it is favourable to form the second PTC heating device 6 with a significantly higher reference temperature T_{2Ref} in order to adapt the optimal heating output range of the second PTC heating device 6 to the temperature level of the air 10 already increased by the first PTC heating device 4. Here, (T_{2Ref}−T_{1Ref})>10° Celsius or >15° Celsius particularly preferably applies for example, wherein for example the reference temperature T_{1Ref} of the first PTC heating device 4 can be smaller than or equal to 155° Celsius while the reference temperature T_{2Ref} of the second PTC heating device 6 can be greater than or equal to 165° Celsius. By way of this, the circumstance that the air 10 or generally the fluid flowing through the heating arrangement 1 when flowing through the second PTC heating device 6 already has a higher temperature level is taken into account.

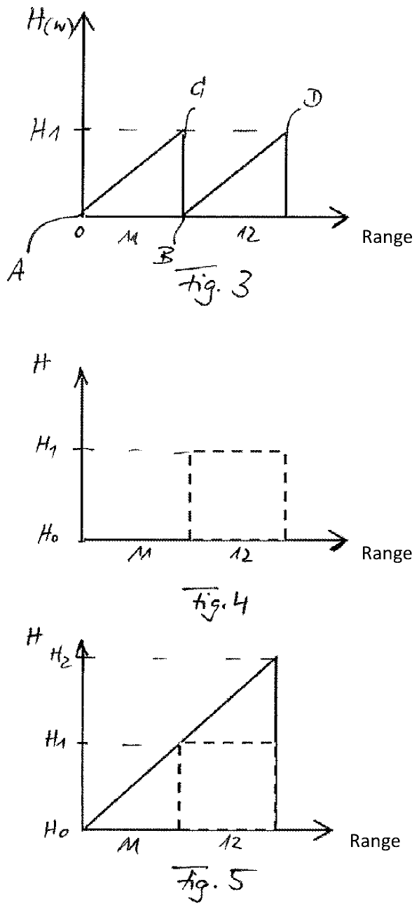

In a further advantageous embodiment of the solution according to the invention the device 9 is designed in such a manner that it can control at least the second PTC heating device 6 by means of pulse width modulation. Such a pulse width modulation is shown in FIG. 3 in different diagrams, wherein on the abscissa the heating output in percent and on the ordinate the pulse width w likewise in percent is plotted.

In the diagrams of FIGS. 3 to 5, the heating outputs H of two PTC heating devices 4, 6 are recorded, which produce the same heating output. With in each case fully activated PTC heating device 4, 6 these bring 100% of their output each, which in each case corresponds to 50% of the heating output of the heating arrangement 1.

Looking at FIG. 3 a pulse width-modulated second PTC heating device 6 is noticeable in these diagrams, in which the pulse width-dependent heating output H in the first and second range 11, 12 in the points A and B at 0% modulated pulse width w amounts to 0%, while the heating output H in the points C and D with 100% pulse width w there amounts to 100% of the heating output H of the second PTC device 6. This corresponds to 50% of the heating output of the entire heating arrangement 1.

In the diagram of FIG. 4 the first PTC heating device 4 is shown, in which no pulse width modulation whatsoever is carried out, so that the same can be merely switched on and off and then generates either 0 or 100% heating output of the first PTC heating device 4. Here, the first PTC heating device 4 is shown in the range 11 in the switched-off state and in the second range 12 in the switched-on state. Here, it produces in the switched-on state 100% of the heating output H of the first PTC heating device 4, i.e. H₁, which corresponds to 50% of the heating output H₂ of the entire heating arrangement 1 with simultaneously activated first and second PTC heating device 4, 6.

When these two differently controlled PTC heating devices 4, 6 are now combined, the diagram of FIG. 5 is obtained, in which in a first range 11, via which 0 to 50% of the heating output H of the heating arrangement 1 can be covered, exclusively the second PTC heating device 6 is subjected to a pulse width between 0≤w≤100%. By way of this a heating output H of H₀≤H≤H₁, can be achieved, wherein H₁ corresponds to 50% of the heating output of the heating arrangement 1.

Here, the second PTC heating device 6 can be switched off or their pulse width w run down to 0% and subsequently merely the first PTC heating device 4 activated. In this case, the heating output H would remain at H₁. When now the heating output is to be further increased, the first PTC heating device 4 in a second range 12 can be continued to be operated with constant voltage while the second PTC heating device 6 is subjected to a pulse width of 0%≤w≤100% and thereby a heating output H₁≤H≤H₂ adjusted. By way of this, a superimposition of the first PTC heating device 4 operated with constant voltage and the second PTC heating device 6 controlled with pulse width modulation occurs. By way of this, a complete coverage of a heating output curve is comparatively easily possible.

Here it is obviously conceivable that the individual first PTC heating elements 5 or the individual second PTC heating elements 7 or the first PTC heating device 4 and the second PTC heating device 6 can have different sizes or forms or the same size and the same form. Likewise it is obviously conceivable that besides the second PTC heating device 6 at least one further PTC device (not shown) is additionally arranged in the through-flow direction 8 after the second PTC heating device 6, wherein the at least one further PTC heating device comprises at least one further PTC heating element and wherein it is true that (T_{wRef}−T_{2Ref}) is at least >5° Celsius. By way of this, a further finer regulation of the heating output of the heating arrangement 1 is possible.

With the heating arrangement 1 according to the invention and the operating method according to the invention it is possible to reduce the dimensions of the current-carrying components, for example conductor tracks and also voltage and current peaks and thereby the vehicle electrical system load, as a result of which the entire vehicle electrical system can be designed for lower loads and thus cost-effectively. Through the individual combinability of the individual PTC heating devices 4, 6 a boost function can also be comparatively easily available for short-term maximum outputs, here through the pulse width-modulated second PTC heating device 6, without the entire vehicle electrical system having to be designed for comparatively high loads. In addition to this, a temperature and volumetric flow monitoring is also possible since the multi-stage PTC heating arrangement 1, besides the functionality of the heating, can also use the individual PTC heating elements 5, 7 as measuring elements for determining physical quantities.

1. A heating arrangement, comprising:
a first PTC heating device with at least one first PTC heating element; and
a second PTC heating device with at least one second PTC heating element;
wherein the first and second PTC heating devices are arranged in a through-flow direction one behind the other; and
wherein the first and second PTC heating devices are controllable independently of one another via a controller.

2. The heating arrangement according to claim 1, wherein the first PTC heating device has a first reference temperature T_{1Ref} and the second PTC heating device a second reference temperature T_{2Ref}, wherein (T_{2Ref}−T_{1Ref})>5° C. applies.

3. The heating arrangement according to claim 2, wherein one of:
(T_{2Ref}−T_{1Ref})>10° C.; or
(T_{2Ref}−T_{1Ref})>15° C.

4. The heating arrangement according to claim 1, wherein the controller controls at least the second PTC heating device via pulse width modulation.

5. The heating arrangement according to claim 2, wherein T_{1Ref}<155° C.

6. The heating arrangement according to claim 2, wherein T_{2Ref}>165° C.

7. The heating arrangement according to claim 1, wherein the second PTC heating device is arranged in the through-flow direction after the first PTC heating device.

8. The heating arrangement according to claim 1, wherein at least one further PTC heating device is arranged in the through-flow direction after the second PTC heating device, wherein the at least one further PTC heating device includes at least one further PTC heating element and a reference temperature T_{wRef}, and wherein (T_{wRef}−T_{2Ref})>5° C.

9. The heating arrangement according to claim 1, wherein at least the second PTC heating device has at least one of a size and a form other than the first PTC heating device.

10. The heating arrangement according to claim 1, wherein at least the first and the second PTC heating devices are permanently joined to one another.

11. A method for operating a heating arrangement comprising adjusting a heating output of at least one of a first PTC heating device and a second PTC heating device via pulse width modulation, wherein the first and second PTC heating devices each has a respective at least one PTC heating element, are arranged in a flow-through direction one behind the other, and are controllable independently of one another via a controller.

12. The method according to claim 11, wherein the first PTC heating device is operated without pulse width modulation and the second PTC heating device with pulse width modulation.

13. The method according to claim 12, wherein:
a first range exclusively, the second PTC heating device is controlled with a pulse width of 0%≤w≤100% such that a heating output within the first range is adjusted;
at the end of the first range, the pulse width w is adjusted to 0% and the second PTC heating device is switched off, and the first PTC heating device is operated with constant voltage without pulse width modulation; and
in a second range, the first PTC heating device is continued to be operated with constant voltage and the second PTC heating device is subjected to a pulse width of 0%≤w≤100% and such that heating output is adjusted.

14. An air-conditioning system of a motor vehicle comprising a heating arrangement including:
a first PTC heating device with at least one first PTC heating element; and
a second PTC heating device with at least one second PTC heating element;
wherein the first and second PTC heating devices are arranged in a through-flow direction one behind the other; and
wherein the first and second PTC heating devices are controllable independently of one another via a controller.

15. The air conditioning system according to claim 14 wherein the first PTC heating device has a first reference temperature T_{1Ref} and the second PTC heating device a second reference temperature T_{2Ref}, wherein (T_{2Ref}−T_{1Ref})>5° C.

16. The air conditioning system according to claim 15, wherein one of:
(T_{2Ref}−T_{1Ref})>10° C.; or
(T_{2Ref}−T_{1Ref})>15° C.

17. The air conditioning system according to claim 14, wherein the controller controls at least the second PTC heating device via pulse width modulation.

18. The air conditioning system according to claim 15, wherein T_{1Ref}<155° C.

19. The air conditioning system according to claim 15, wherein T_{2Ref}>165° C.

20. The air conditioning system according to claim 14, wherein the second PTC heating device is arranged in the through-flow direction after the first PTC heating device.
